(19) United States
(12) Patent Application Publication
(10) Pub. No.: US 2009/0280368 A1
(43) Pub. Date: Nov. 12, 2009

(54) METHOD FOR MANUFACTURING A MICROREACTOR WITH INCREASED EFFICIENCY FOR SUPPLYING A SYSTEM FOR THE PRODUCTION OF ENERGY FOR MICRO CELL PORTABLE APPLICATIONS

(75) Inventors: Giuseppe Spoto, San Giovanni La Punta (CT) (IT); Cristian Dall'Oglio, Niscemi (CL) (IT); Roberta Zito, Modugno (BA) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 12/409,181

(22) Filed: Mar. 23, 2009

(30) Foreign Application Priority Data
Apr. 8, 2008 (IT) MI2008A000615

(51) Int. Cl. H01M 8/18; B01J 7/00; B05D 5/12; B44C 1/22

(52) U.S. Cl. 429/19; 422/222; 427/115; 216/99

(57) ABSTRACT

A method for forming an increased efficiency microreactor for an energy production for portable applications includes at least one micro fuel cell. The microreactor has a reaction chamber including a catalyst for the production of gaseous hydrogen to be supplied to the micro fuel cell. The method may include providing at least one first silicon die, a face thereof defining an active surface of the reaction chamber. The method may include anisotropically etching the at least one first silicon die for realizing a plurality of notches and countershaped ridges suitable for increasing the area of the active surface so as to define an increased active surface. The method may also include depositing on at least one portion of the increased active surface a layer of the catalyst.

### FIELD OF THE INVENTION

The present invention relates to the industrial field of hydrogen-supplied micro fuel cells for generating electric energy, particularly but not exclusively intended for being used in portable electronic applications.

### BACKGROUND OF THE INVENTION

The growing miniaturization of portable electronic applications has determined an intense, strong interest of the experts of the field towards the identification, design and realization of new electric energy sources in addition to and overcoming the traditional batteries so far used for the above purpose, for example lithium ions batteries.

Among the new portable electric energy sources, micro fuel cells, hereafter indicated as microcells, i.e. those devices capable of obtaining electric energy from a suitable fuel through oxide-reduction reactions, have raised great interest.

A micro fuel cell is schematically shown in FIG. 1, globally indicated with 1. In particular, the micro fuel cell shown is of the polymeric solid electrolyte type [Proton Exchange Membrane Fuel Cells].

Such a micro fuel cell 1 essentially includes two electrodes, an anode A, and a cathode C, separated by an electrolyte, which, in the case considered, instead of being liquid, is solid and includes a thin polymeric membrane, which allows the passage of the protons H+ only from the anode A to the cathode C membrane or Proton Exchange Membrane (PEM).

In particular, the use of structure electrode-membrane or membrane electrode assembly (MEA) of the type shown in FIG. 1, suitably enclosed sandwich-like between the anode A and the cathode C to form the micro fuel cell 1, is well known as advantageous.

Micro fuel cells are essentially energy converters which, by exploiting the energetic content of a chemical fuel, through an oxide-reduction reaction, allow the production of electric energy in a reversible way, supplying reaction collateral products, in particular heat and water.

At present, attention has been drawn to fuels such as hydrogen and ethanol, which are preferred because, if suitably treated in the microcells, they allow an easy, clean obtainment of electric energy, with high efficiency.

It has also been ascertained that the density of energy that can be obtained from a hydrogen-supplied micro fuel cell is, under identical conditions, greater of some orders of magnitude than the one that can be obtained from a similar methanol-supplied microcell. Hydrogen is thus the fuel to be used for micro fuel cells, which typically require a high power density, such as in the case of portable applications.

It has also been ascertained that to obtain, from a hydrogen microcell, electric energy amounts enough for a satisfying prolonged operation of a respective portable electronic device, in particular energy amounts enough to justify a gradual substitution of the batteries currently used as portable energetic sources, it may be desirable that the microcell has a consistent hydrogen “storage.”

For the above purpose, microreactors or generators of catalytic hydrogen 2 have been used, for example, as shown in FIG. 2, which receive a liquid fuel solution from a suitable storage tank 3, for generating the gaseous hydrogen to be supplied to the anode A of the microcell 1.

The microreactors 2 include a reaction chamber including a suitable catalyst for the production of gaseous hydrogen, as well as a liquid-gas separator. This allows separation of the gaseous hydrogen produced by the reaction by-products, which are collected in a second tank 4.

Still, further methods of making a microreactor for a micro fuel cell, having functional and structural characteristics, which allow improved performance and efficiency, and also allow reduction of the overall size of the energy production system are desired.

### SUMMARY OF THE INVENTION

According to the present invention, a method for the formation of an increased efficiency microreactor for a system of energy production for portable applications of the above indicated type includes providing at least one first silicon die, a face thereof defining an active surface of the reaction chamber. The method also includes anisotropically etching the at least one first silicon die to realize a plurality of notches and countershaped ridges, which increase the area of the active surface so as to define an increased active surface. The method further includes depositing on at least one portion of said increased active surface, a catalyst layer.

Further, a microreactor and by a device for the production of energy for portable applications may be respectively obtained according to the methods described herein.

The characteristics and the advantages of the method, of the microreactor and of the device according to the present invention will be apparent from the following description of an embodiment thereof given by way of indicative and non-limiting example with reference to the annexed drawings.

### BRIEF DESCRIPTION OF THE DRAWINGS

FIG. 1 is a schematic block diagram of a micro fuel cell, according to the prior art.

FIG. 2 is a schematic block diagram of a device for the production of energy, according to the present invention.

FIG. 3 is a perspective view of a silicon crystalline structure.

FIG. 4 is a representation on Cartesian planes of a cubical crystal.

FIGS. 5 and 6 are schematic cross-sectional views of anisotropic trenches of a portion of a silicon substrate, according to the present invention.

FIG. 7 is a schematic diagram of a microtreated silicon substrate for a reaction chamber, according to the present invention.

FIGS. 8 and 9 are sections of the silicon substrate before and after an anisotropic chemical etching, according to the present invention.

FIG. 10 is an enlarged view of a portion of the substrate of FIG. 9.

FIGS. 11 and 12 are top views of the silicon substrate of FIGS. 8 and 9;

FIGS. 13 and 14 are Transmission Electron Microscopy (TEM) microscopic views in different scales, of a portion of the silicon substrate of FIG. 12.

FIG. 15 is a TEM microscopic view of a section of the silicon substrate of FIG. 9.

FIG. 16 is a schematic representation of a square base pyramid, according to the present invention.

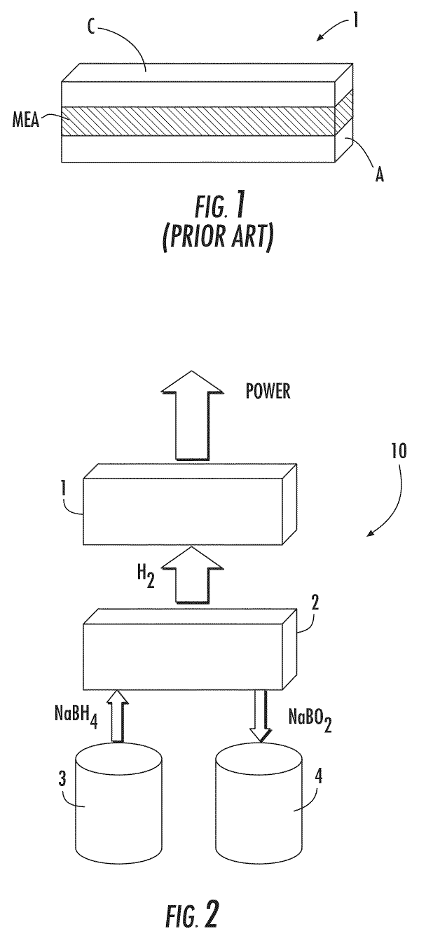

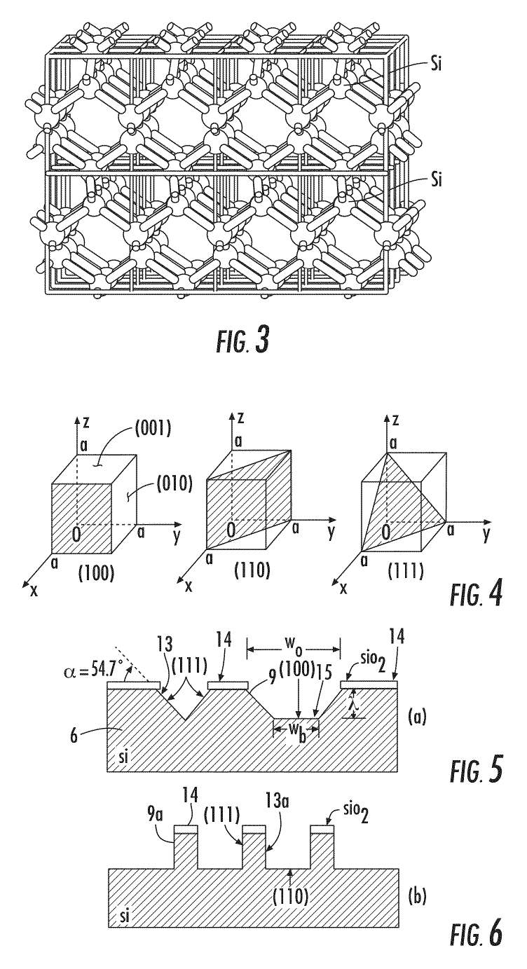

### DETAILED DESCRIPTION OF THE PREFERRED EMBODIMENTS

With reference to the annexed figures, a method is described for forming an increased efficiency microreactor for a system for the production of energy for portable applications of the type including at least one micro fuel cell 1.

The microreactor 2 includes a reaction chamber 7 including a catalyst which, by chemically reacting, through a suitable oxide-reduction reaction with a fuel solution, produces gaseous hydrogen H₂ to be supplied to the micro fuel cell 1. Advantageously, the method according includes providing at least one first silicon die 6, a face thereof defining an active surface 8 of the reaction chamber 7. The method also includes anisotropically etching the first silicon die 6 for forming a plurality of notches 13 and of countershaped ridges 9 for widening the area of the active surface 8 to define an increased active surface 8a.

Suitably, the method also includes depositing on at least one portion of the increased active surface 8a a catalyst layer. The silicon in its crystalline form is grey and shows metallic lustre. Moreover, it is a relatively inert element, and reacts with the halogens and the alkalis. However, most of the acids, except for hydrofluoric acid, do not etch it.

FIG. 3 shows the crystalline structure of a plurality of identical silicon Si atoms, each of them surrounded by four prime atoms, placed at the vertexes of a tetrahedron, which define a lattice belonging to the family of the cubic crystals.

In a conventional way, the planes of a crystal are defined through Miller indexes. FIG. 4 illustrates primary planes of a cubic crystal indicated according to these indexes. In particular, FIG. 4 illustrates a first plane 100, a second plane 110 and a third Miller plane 111.

Due to the crystalline structure of the first silicon die 6, the etching solutions melt a crystalline plane more quickly than another, making the chemical etching anisotropic. In particular, in the first silicon die 6, the third plane (111) has greater atomic density with respect to the first plane (100) and thus for this third plane (111) the etching velocity is lower.

The anisotropic etching step of the active surface 8 mainly etches the silicon Si atoms oriented naturally, i.e. showing a crystallographic arrangement, along the first Miller plane 100 defining the plurality of notches 13 and countershaped ridges 9.

Suitably, the method uses a first silicon die 6 showing the silicon Si atoms mainly oriented along the first Miller plane 100. In other words, the method provides using the first silicon die 6 “cut” along the first Miller plane 100.

Advantageously, in this way, the notches 13 obtained by the anisotropic etching step show the side walls arranged along a plane forming an angle α equal to 54.7° with respect to the active surface 8. This plane a corresponds to the third Miller plane 111.

The method also provides carrying out this anisotropic etching by a wet chemical etching, which preferably uses potassium hydrogen, and uses a silicon dioxide mask 14 (SiO₂) mapped with suitable openings 15.

Suitably, the openings 15 are non uniform with respect to each other and allow a forming of notches 13 which, in the present embodiment, can be, according to a section perpendicular to the active surface 8, substantially “V-like” or “U-like” shaped. This latter “U-like” shape is formed when the opening 15 shows a width “Wₒ” wide enough, or a short etching time.

These notches 13 are thus, advantageously, non uniform with respect to each other and in relation to the width Wo of the openings 15, and were also in relation to the physical parameters of the chemical etchings, such as, for example, duration and temperature.

According to an embodiment, after the anisotropic etching step with potassium hydroxide (KOH), the active surface 8 includes the plurality of notches 13 and countershaped ridges 9, defining an increased active surface 8a. Advantageously, the ridges 9 show a pyramid-like shape, with a substantially square base, whose side surfaces increase the active surface 8 of the first silicon die 6. In this way the increased active surface 8a increases the silicon area, whereon the catalyst layer is deposited, which follows its morphology.

The method provides that the deposition step of the catalyst layer occurs, advantageously, through sputtering by employing, as a catalyst, a metal of the group VIIIB of the periodic table of the elements. In particular, the metal is chosen from among Cobalt, Nickel, Platinum and Ruthenium, and is preferably Ruthenium.

Advantageously, by increasing the active surface 8 with the side surface of the substantially pyramid-shaped ridges 9, the amount of the catalyst deposited on the increased active surface 8a is increased, thus increasing the amount of gaseous hydrogen H₂ developed, for the benefit of the microreactor 2 efficiency. On the increased active surface 8a, a plurality of catalyst covered microchannels is created whereon the liquid fuel solution can flow reacting with the catalyst and generating gaseous hydrogen H₂.

Further, the method provides one or more formation steps on the first silicon die 6, to define a first input hole 18 and a second output hole 19 respectively in fluid communication with a first tank 3, for the storage of a fuel solution suitable for reacting with the catalyst, and a second tank 4, for the storage of by-products, deriving from the chemical reaction between the fuel solution and the catalyst.

Moreover, the method can advantageously provide a mapping step, which precedes the anisotropic chemical etching. The mapping step is suitable for defining photolithographic techniques, suitable protected areas of the active surface 8 that cannot be etched by the successive anisotropic chemical etching step, and/or forming, in the active surface 8, a single microchannel 17, which curls between the first input hole 18 and the second output hole 19, wherein the fuel solution can flow. In this case, the anisotropic etching step and the catalyst deposition step occurs in correspondence with the microchannel 17.

Advantageously, the microreactor 2 is defined by the interposition of a semipermeable membrane, i.e. a liquid-gas separator being gas-permeable but liquid-impermeable of the known type shown in the figures. This semipermeable membrane is suitably arranged above the first silicon die 6 and is, in particular, juxtaposed with respect to the reaction chamber 7. The semipermeable membrane also allows the passage of the gaseous hydrogen H₂ from the anode A of the overlapped micro fuel cell 1. According to another embodiment, the microreactor 2 can also include a closing cover defined by a second silicon die, microtreated and suitably associated with the first silicon die 6.

Advantageously, according to an embodiment, the anisotropic etching step preferably uses a solution including potassium hydroxide (KOH) of 30% by weight as well as distilled water. Suitably, the anisotropic etching step occurs at a temperature, which is substantially the environment temperature, 20° C., and has a duration of 120 hours, and preferably, under a pressure of 1 bar.

Advantageously, the method provides that the solution used includes an enhancing agent suitable for increasing the anisotropy of the anisotropic etching step. Such enhancing agent is preferably isopropyl alcohol.

A possible “recipe” of this solution includes 70 g of KOH in pellets, to which 190 ml of distilled water are added. When the KOH has melted, 40 ml of isopropyl alcohol are added.

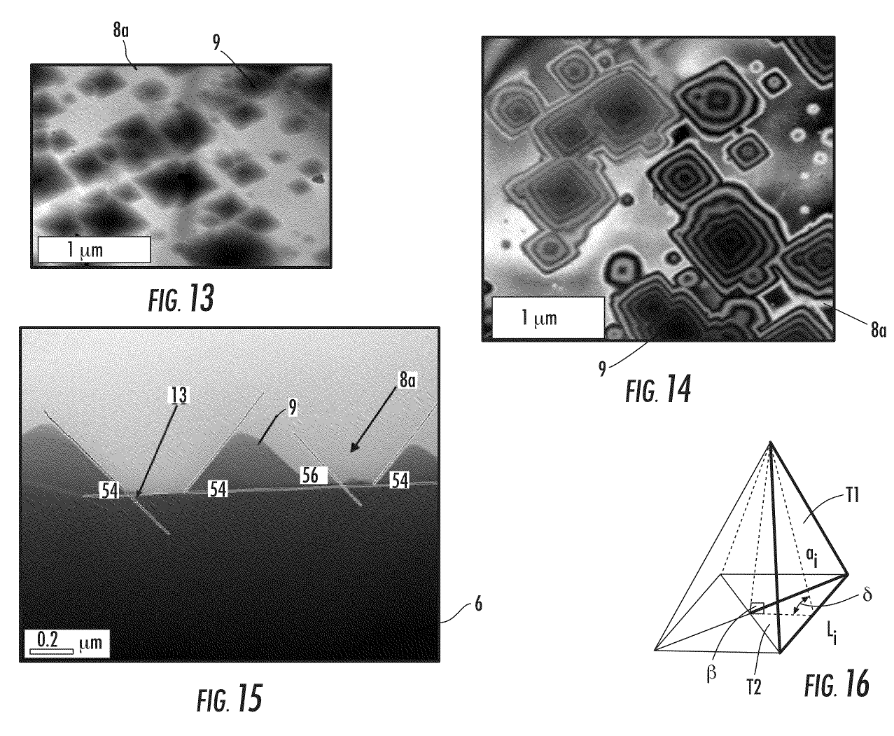

In particular, the Applicant has analyzed some images of the TEM type of the increased active surface 8a of some samples of silicon dies, after having been subjected to the anisotropic etching step with the indicated to a “recipe”. The images analyzed correspond to those reported in FIG. 13. The Applicant has thus elaborated these images, by suitable data processing software, and has calculated the area occupied by the plurality of ridges 9 in a suitable portion of increased active surface 8a.

More particularly, the Applicant has analyzed a portion of the area of the increased active surface 8a equal to 10.2 μm² calculating the number of the pyramids present in each portion. Considering that the pyramids have a substantially square base, the equation deduced is:

N*A_{base}=N*Li² (1)

where:
N=number of pyramids
A_{base}=mean base area of the pyramids
Li=mean side of the pyramids

By this equation (1) it is possible to calculate for each TEM image the mean side of the pyramids.

Table 1 reports data deduced from the images, i.e. in order: the sum of the areas of the pyramids with square bases, the number of pyramids present in each portion of the area considered, the area which is not covered by pyramids, and the mean side of the pyramids.

TABLE 1

| | N*Abase (μm²) | N | Remaininq Area (μm²) | Li (μm) |
|---|---|---|---|---|
| TEM1 image | 4.9 | 58 | 5.3 | 0.291 |
| TEM2 image | 4.5 | 68 | 5.7 | 0.257 |
| TEM3 image | 6.6 | 75 | 3.6 | 0.297 |

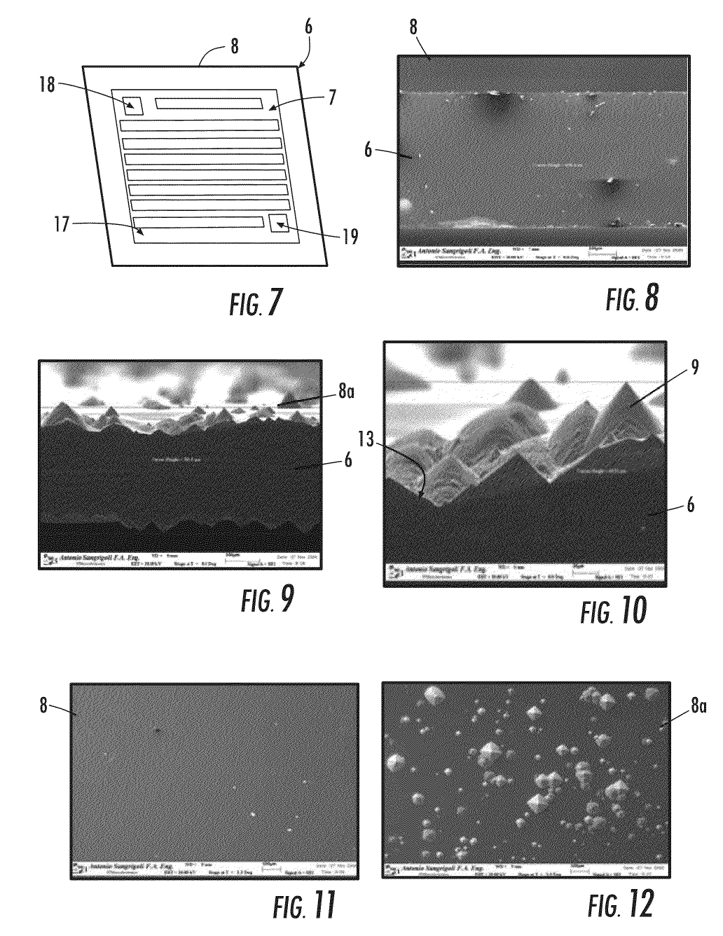

When the silicon die 6 is etched, the anisotropic etching step leaves, on the surface, the plurality of notches 13 and of countershaped ridges 9, i.e. the emerging pyramids having square bases, similar to the pyramid illustrated in FIG. 16 and also illustrated in FIGS. 8 and 9. With a formula it is possible to go back to the area of the side surface of each pyramid. In particular, it can be noted how each of the four triangles identified by the base diagonals a, b is univocally correlated to the corresponding triangle of the side surface where the height is inclined with respect to the base of an angle δ of 54° as it can be deduced also from the image of FIG. 15.

The ratio between the area of the side triangle T1 forming a side face of the pyramid and the area of the base triangle T2, determines the increase of the active surface 8 and is given by the following relation (2):

$$with ai = Li / ( 2 * cos δ ) \\ \frac{\frac{Li * ai}{2}}{\frac{Li * Li / 2}{2}} = \frac{{Li}^{2} / 4 cos δ}{{Li}^{2} / 4} = \frac{1}{cos δ} \qquad ( 2 )$$

From this relation the ratio between the increased active surface 8a of the first silicon die 6 resulting from the anisotropic etching in KOH and the active surface 8, virgin i.e. non etched, is given by the following relation:

$$\frac{N * Abase * ( 1 / cos δ ) + Remaining Area}{Total Area} = Area Increasing \qquad ( 3 )$$

Table 2 reports for each TEM image, and considering the values reported in Table 1, the ratio and the percentage increase between the area of the increased active surface 8a after the anisotropic etching step with potassium hydroxide KOH and the area of the virgin, active surface 8. This ratio thus determines the area increase obtained by the anisotropic chemical etching step.

TABLE 2

| | Area Ratio (μm²) | Area Percentage Increase |
|---|---|---|
| TEM1 image | 1.34 | 34% |
| TEM2 image | 1.31 | 31% |
| TEM3 image | 1.45 | 45% |

A second embodiment of the method provides a first silicon die (6) with the atoms mainly oriented along the second Miller plane 110.

In this case, the anisotropic etching step produces a plurality of second notches 13a and countershaped second ridges 9a, which, advantageously, show, due to the orientation of the crystal planes, the side walls substantially perpendicular to the active surface 8 of the first silicon die 6.

Also in this second embodiment, the increased active surface 8a, includes the plurality of second notches 13a and corresponding second ridges 9a, has a greater area with respect to the area of the virgin, active surface 8, for the benefit of the amount of catalyst which is deposited on the first silicon die 6.

The method can provide using a fuel solution of Sodium Borane (NaBH₄), which can be supplied by the first storage tank 3 to the reaction chamber 7 of external microfluidic systems such as pumps and/or microvalves or injected by using suitably sized pressurised tanks.

An embodiment also relates to a microreactor for portable applications. The microreactor includes a reaction chamber having a catalyst for the production of gaseous hydrogen H₂ as previously described, for which particulars and cooperating parts having the same structure and function are indicated with the same numbers and reference acronyms.

The microreactor 2 advantageously includes at least one first silicon die 6 having a face defining an active surface 8 of the reaction chamber 7.

In particular, the active surface 8 includes a plurality of notches 13 and countershaped ridges 9, suitably obtained by an anisotropic etching step to the virgin, active surface 8. Advantageously, the first silicon die 6 has the silicon Si atoms mainly oriented along a first Miller plane 100. The ridges 9 increase the area of the active surface 8 defining for the first silicon die 6, an increased active surface 8a.

Advantageously the anisotropic etching step occurs by a potassium hydroxide KOH solution, and at environment temperature and pressure.

Further, the microreactor 2 also includes a catalyst layer deposited, by a sputtering step, for example, on at least one portion of the increased active surface 8a. Suitably, the anisotropic etching step includes etching the Si atoms of the first die 6 oriented along the first Miller plane 100.

In this way, the ridges 9 obtained by the anisotropic etching step, and the first silicon die 6 with the atoms oriented along the first Miller plane 100, have a pyramidal shape preferably with a square base and with inclined side walls, with respect to the corresponding base, of an angle δ, and substantially equal to 54°. An area increase of the increased active surface 8a with respect to the active surface 8 can be obtained as a result.

Advantageously, the catalyst is a metal of the group VIIIB of the periodic table of the elements. In particular the catalyst is a metal chosen among Cobalt, Nickel, Platinum and Ruthenium, and is preferably Ruthenium.

According to an embodiment, on the catalyst layer placed on the increased active surface 8a of the microreactor 2, a fuel solution, for reacting with the catalyst for the production of the gaseous hydrogen H₂, flows. The fuel solution is an aqueous solution of Sodium Borane (NaBH₄). Further, the first silicon die 6 includes a first input hole 18 and a second output hole 19 respectively in fluid communication with a first tank 3 for the storage of the fuel solution, and a second tank 4 for the storage of by-products deriving from the reaction.

In the specific case, the chemical reaction for the production of gaseous hydrogen H₂ from Sodium Borane is the following:

catalyst

NaBH₄+2H₂O→4H₂+NaBO₂(aq)+300KJ

This reaction is exothermal and occurs under environment pressure and temperature. Further, the by-products of the reaction include boron oxides, which are soluble in water and non-polluting.

The microreactor 2, according to a further embodiment, includes a microchannel 17 formed in the active surface 8 of the first silicon die 6, which curls between the first input hole 18 and the second output hole 19. According to this embodiment, the microchannel 17 includes a plurality of ridges 9 formed inside the microchannel itself with preferable pyramid-like shape.

Further, in a second embodiment of the microreactor 2, the first silicon die 6 shows a plurality of second notches 13 and countershaped ridges 9. These latter with the side walls substantially perpendicular to the active surface 8. According to this embodiment, the atoms of the active surface 8 of the first silicon die 6 etched by the anisotropic etching step are mainly oriented along a second Miller plane, for example 110.

In the above described embodiments, the microreactor 2 may include a second silicon die on the first silicon die 6 with an interposed semipermeable membrane, i.e. a liquid-gas separator which lets the gaseous hydrogen H₂ produced pass towards the cathode of a overhanging microcell. The second die and the membrane are not shown in the annexed figures. The microreactor 2 can be advantageously used in a device for the production of energy for portable applications of the type including at least one micro fuel cell 1 suitably associated with the microreactor 2.

An advantage of the embodiments is given by the increase of the production of gaseous hydrogen H₂ produced in the reaction chamber, which is approximately equal to an increase proportional to the increase of the area of the active surface obtained. This makes the portable electronic devices more efficient for the production of energy, wherein these microreactors are employed to produce a same amount of gaseous hydrogen H₂ employing microreactors with reduced sizes.

Another advantage is given by the particularly advantageous and economic combination of the production steps for forming the microreactor. Another advantage is given by the fact that the microreactor knows a priori the increase of the active surface area, and thus, the production of gaseous hydrogen H₂.

A further advantage of the microreactor is the versatility of use, since it can be associated with microcells of a known type. A further advantage of the microreactor is the remarkably favorable achievement from the viewpoint of the environment respect, in fact, the microreactor produces reduced non-polluting by-products.

1-26. (canceled)

27. A method for forming a microreactor comprising a reaction chamber including a catalyst for producing gaseous hydrogen to be supplied to at least one micro fuel cell, the method comprising:
providing at least one first silicon die defining an active surface of the reaction chamber;
anisotropically etching the at least one first silicon die to form a plurality of notches and ridges to define an increased active surface; and
depositing a layer of the catalyst on at least one portion of the increased active surface.

28. The method according to claim 27 wherein providing the at least one first silicon die comprises providing the at least one first silicon die with silicon atoms oriented along a first Miller plane (100).

29. The method according to claim 28 wherein the anisotropic etching defines the plurality of ridges to form a pyramid-like shape.

30. The method according to claim 29 wherein the anisotropically etching defines the pyramid-like shaped ridges to have a square base and side walls with an inclination of an angle equal to 54° with respect to the square base.

31. The method according to claim 27 wherein providing the at least one first silicon die comprises providing the at least one first silicon die to have silicon atoms oriented along a second Miller plane (110).

32. The method according to claim 31 wherein the anisotropic etching defines the plurality of ridges to have side walls substantially perpendicular to the active surface of the at least one first silicon die.

33. The method according to claim 27 wherein anisotropically etching comprises a wet chemical etching using potassium hydroxide and a silicon dioxide mask with non-uniform openings.

34. The method according to claim 33 wherein the anisotropic etching forms the plurality of notches and ridges to be shaped in relation to a width of the non-uniform openings and to physical parameters of the wet chemical etching.

35. The method according to claim 27 wherein the anisotropic etching occurs at room temperature.

36. The method according to claim 35 wherein a duration of the anisotropic etching is about 120 hours.

37. The method according to claim 27 wherein anisotropically etching comprises using a solution comprising potassium hydroxide at 30% by weight and distilled water.

38. The method according to claim 37 wherein the solution further comprises isopropyl alcohol for increasing the anisotropy of the anisotropic etching.

39. The method according to claim 27 further comprising mapping protected areas prior to the anisotropic etching, the mapping of protected areas comprising defining, by photolithographic techniques, areas that are not subject to the anisotropic etching and formatting of a microchannel in the active surface prior to the anisotropic etching.

40. The method according to claim 27 wherein depositing a layer of the catalyst occurs via sputtering; and wherein the catalyst is a metal of the group VIIIB.

41. The method according to claim 40 wherein the metal is selected from Cobalt, Nickel, Platinum, and Ruthenium.

42. The method according to claim 27 further comprising forming a first input hole and a second output hole in the at least one first silicon die, the first and second holes being respectively in fluid communication with a first tank for storing a fuel solution for reacting with the catalyst, and a second tank for storing by-products.

43. The method according to claim 42 wherein the fuel solution comprises an aqueous solution of Sodium Borane.

44. A microreactor comprising:
a reaction chamber including a catalyst for the production of gaseous hydrogen;
at least one first silicon die having a face to define an active surface for said reaction chamber;
the active surface comprising a plurality of notches and ridges to define an increased active surface; and
a catalyst layer on at least a portion of said increased active surface.

45. The microreactor according to claim 44 wherein the plurality of ridges comprises a plurality of pyramid-like shaped ridges.

46. The microreactor according to claim 45 wherein the plurality of pyramid-shaped ridges each comprises a square base and side walls having an inclination of an angle equal to 54° with respect to the square base.

47. The microreactor according to claim 46 wherein the side walls are substantially perpendicular to the active surface of the at least one first silicon die.

48. The microreactor according to claim 46 wherein the catalyst comprises a metal of the group VIIIB.

49. The microreactor according to claim 48 wherein the metal is selected from Cobalt, Nickel, Platinum, and Ruthenium.

50. The microreactor according to claim 48 further comprising a fuel solution flowing above the catalyst layer for reacting with the catalyst, said fuel solution comprising a Sodium Borane aqueous solution.

51. A microreactor according to claim 44 further comprising:
a first tank for storage of a fuel solution; and
a second tank for storage of by-products;
said at least one first silicon die having a first input hole in fluid communication with said first tank, and a second output hole in fluid communication with said second tank.

52. A microreactor according to claim 51 wherein the active surface further comprises a microchannel positioned between said first output hole and said second output hole.

53. The microreactor according to claim 44 further comprising a second silicon die on said at least one first silicon die, and a semipermeable membrane positioned therebetween.

54. A device for the production of energy for portable applications comprising:
at least one micro fuel cell; and
a microreactor comprising
a reaction chamber including a catalyst for the production of gaseous hydrogen,
at least one first silicon die having a face to define an active surface for said reaction chamber,
the active surface comprising a plurality of notches and ridges to define an increased active surface, and
a catalyst layer on at least a portion of said increased active surface.

55. The device according to claim 54 wherein said microreactor further comprises:
a first tank for storage of a fuel solution; and
a second tank for storage of byproducts;
said at least one first silicon die having a first input hole in fluid communication with said first tank, and a second output hole in fluid communication with said second tank.

56. The device according to claim 55 wherein the active surface further comprises a microchannel positioned between said first output hole and said second output hole.
